(19) United States
(12) Patent Application Publication
(10) Pub. No.: US 2006/0243902 A1
(43) Pub. Date: Nov. 2, 2006

(54) System for detecting explosives and chemical or biological agents

(76) Inventor: Joan Altes Royo, Barcelona (ES)

Correspondence Address: JACOBSON HOLMAN PLLC, 400 SEVENTH STREET N.W., SUITE 600, WASHINGTON, DC, 20004, US

(21) Appl. No.: 11/333,300

(22) Filed: Jan. 18, 2006

(30) Foreign Application Priority Data
Feb. 16, 2005 (ES) 200500337

(51) Int. Cl. H01J 49/00

(52) U.S. Cl. 250/288

(57) ABSTRACT

A system for detecting explosives and chemical or biological agents.

The system comprises an air impeller member and an air suction member (1 and 2) disposed at the sides or above and below a passage threshold (3), generating a continuous air curtain which entrains particles to be analyzed from the persons, clothing or objects passing through said continuous air curtain, the air being drawn in by the suction member (2) and diverted by a diverter valve (4) to the outside or towards the particle detector module (6). The system comprises presence detector means (8) which activate the diverter valve (4) and the detector module (6) for carrying out the analysis, the air flow being sent through an exhaust duct (5) when there is no presence in the threshold (3), and a camera (7) for recording images of the persons or objects passing through the threshold (3).

### FIELD OF THE INVENTION

The present invention relates to a system for detecting explosives and chemical or biological agents; of the type comprising a particle detector module with a gas chromatograph and an ion mobility spectrograph.

### BACKGROUND OF THE INVENTION

Currently the security systems in public and private places have become stricter in view of terrorist threats. In fact, it is common to find access controls at airports, railroad stations, large public or private buildings for detecting and preventing the introduction of potentially dangerous items.

Particularly, it is desired to control the possible entry of products and substances such as explosives and chemical or biological agents which may be especially dangerous. For finding them, further to personal checks, there are particle detector modules which, on absorbing the air around an object or person, are capable of detecting the presence of certain substances which may turn out to be dangerous.

Such detector modules generally comprise a gas chromatograph and an ion mobility spectrograph. The gas chromatograph analyzes a sample of the air containing the possible dangerous substances, which is mixed with an inert gas and the resulting mixture is fed through a cylinder, causing the separation of the particles in the sample depending on their composition.

In a second step of the process, the ion mobility spectrograph analyzes the sample separated by the chromatograph, more reliably identifying each of the substances forming it.

To obtain the initial sample of the air with the possible dangerous substances, there is generally used a vacuum device which is applied to a subject or object to be inspected. Nevertheless, devices of this type are not applicable when it is wanted to control an access area through which there is a highly frequent traffic of persons or various persons pass simultaneously.

### DESCRIPTION OF THE INVENTION

The detector system of the present invention is provided with technical peculiarities easily and speedily facilitating its use for flows of persons through an access threshold without the need of interrupting the progress of the persons. The system is also valid for the inspection and detection of explosives in objects such as baggage and goods carried on conveyor belts and other means of carriage.

The system comprises a particle detector module of the type formed by a gas chromatograph and an ion mobility spectrograph. To allow its use in inspecting a flow of persons or objects, the invention comprises an air impeller member and an air suction member, arranged at facing positions relative to a passage threshold or area to be checked.

Both members generate a continuous curtain of air sweeping said threshold, said curtain being formed by the air exiting through radial or lateral nozzles or slots defined in the air impeller member and gains access to the suction member through also radial or lateral slots or apertures, the air being eventually fed to the detector module.

On crossing the passage threshold or area, any person or object crosses through the air curtain, with said continuous air curtain entraining the particles of the substances impregnated in the person or object. In this way, the continuous air curtain takes the samples to be analyzed by the detector module.

For generating the continuous air curtain, the impeller member comprises a compressor, fan or the like which generates a sufficient pressure of air to supply an exit flow in the lateral nozzles or slots of the impeller member. In turn, to ensure the entry of the continuous air curtain in the suction member, this member is associated with a vacuum member which additionally impels said flow to the detector module.

At the exit from the vacuum member there is a diverter valve, which can send the circulating air flow to the detector module or to an exhaust duct. The purpose of this valve is to send the air flow to be analyzed to the detector module only when it is desired to determine whether it contains particles of potentially dangerous substances, i.e. only when persons or objects are passing through the passage threshold or area. To optimize the operation of the analyzer module, the system is provided with presence sensor means which, on sensing the passage of persons and/or objects through the threshold, activate the particle detector module and operate on the diverter valve, setting it in the position allowing the passage of the circulating air to said detector module.

The feeding of particles by the continuous air curtain up to the detector module and the analytical system used by said particle detector module do not allow an instantaneous result to be obtained, there being a delay between the time of passage through the threshold and the obtaining of said result. To solve this problem, it is contemplated that the system incorporates a recording camera taking images of the passage threshold, allowing suspicious persons or objects to be viewed.

The impeller and suction members may be arranged vertically at both sides of the threshold, or arranged horizontally, the impeller member being at the top and the suction member built into or defined in the floor, with the air entering in said suction member through a grating in the floor. It is contemplated that in either of the above two arrangements the impeller and suction members may be provided with appropriate structures for their self-supporting installation on the floor, without the need for construction work.

### DESCRIPTION OF THE DRAWINGS

To complement the present description and with a view to facilitating an understanding of the features of the invention, there is attached to this specification a set of drawings in which the following has been shown with an illustrative and non-limiting nature:

FIG. 1 is a schematic illustration of the system with the continuous air curtain generating members disposed vertically at both sides of the passage threshold, with the curtain sweeping laterally.

FIG. 2 is a schematic illustration of the system with the impeller member arranged horizontally above the passage threshold and with the suction member built into the floor, the inlet thereto being formed by a grating.

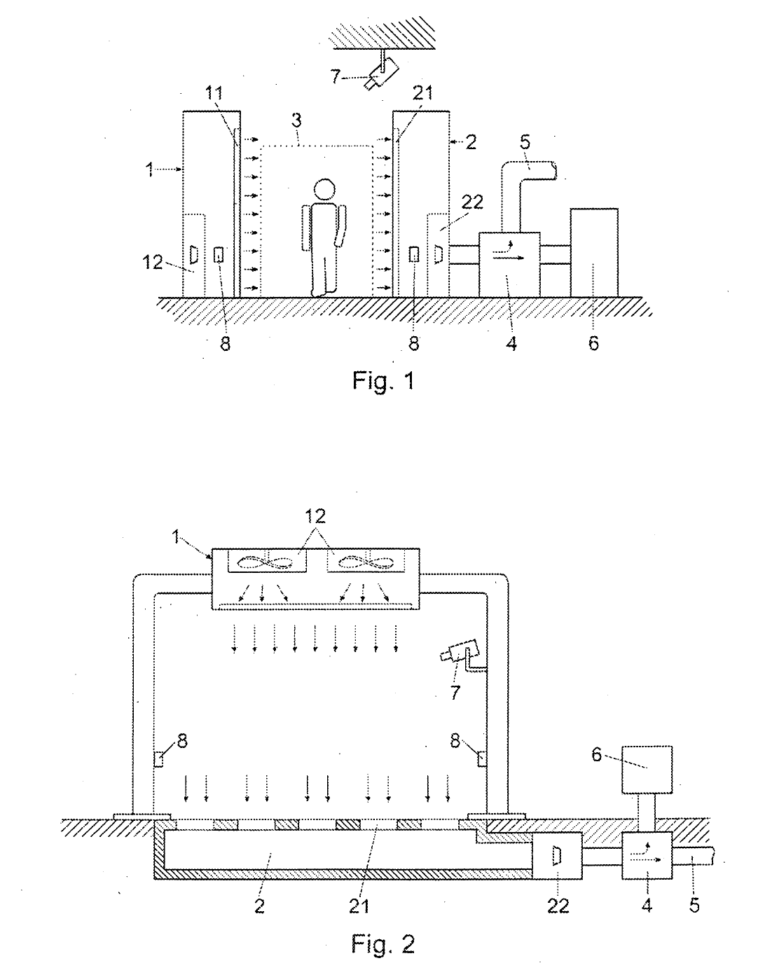

### PREFERRED EMBODIMENT OF THE INVENTION

As may be seen in the Figures, the system comprises an impeller member (1) and a suction member (2), forming therebetween a continuous air curtain covering and sweeping a person and/or object passage threshold (3).

Each member (1 and 2) is formed by an elongate hollow column or duct provided with lateral nozzles or slots (11 and 21) for respectively blowing out and sucking in the air flow forming the curtain. A compressor (12) or fans may be incorporated in said impeller member and an aspirator (22) or suction turbine may be housed in said suction member.

The aspirator (22) of the suction member (2) may optionally be connected over a diverter valve (4) to an exhaust duct (5) to the outside air or to the particle detector module (6).

The conventionally formed detector module (6) may comprise a gas chromatograph and an ion mobility spectrograph for analyzing the substances entrained by the continuous air curtain.

It is contemplated that there be presence detection means (8) in the passage threshold (3) for activating the valve (4) and the particle detector module (6) when a person or object crosses through the threshold being swept by the continuous air curtain.

The system comprises a camera (7) for recording images from the passage threshold (3) and reproduces the images with a delay depending on the period of time required for analyzing the sample in the detector module, with a view to displaying the suspicious persons or objects when the detector module (6) indicates the presence of a particular dangerous substance.

Having sufficiently described the nature of the invention, as well as an example of a preferred embodiment, it is pointed out for the pertinent effects that the materials, shape, size and arrangement of the items described may be altered provided that this does not mean any alteration of the essential features of the invention claimed hereinafter.

1. A system for detecting explosives and chemical or biological agents, of the type comprising a particle detector module with a gas chromatograph and an ion mobility spectrograph, characterized in that:
it comprises an air impeller member and an air suction member, arranged at facing positions relative to a passage threshold or area, said members generating a continuous curtain of air which sweeps said threshold, entraining the particles to be analyzed through the suction member to the particle detector module;
said air impeller member is associated with a compressor or the like, for providing a pressurized air flow emerging as a curtain through nozzles or slots defined in said impeller member;
and said suction member comprises openings or slots for the entry of air sucked in by an aspirator means.

2. The system of claim 1, characterized in that a diverter valve is inserted between the suction member and the particle detector module allowing the flowing air to be diverted towards an exhaust duct when it is not wanted to analyze the particles captured by the continuous air curtain.

3. The system of claim 1, characterized in that it comprises presence detection means in the passage threshold, operatively adapted to activate the particle detector module and the air diverter valve, allowing the analysis when a person or object passes through the threshold and leaving the detector module inactive when the passage of persons or objects through the threshold is not detected.

4. The system of claim 1, characterized in that it comprises a camera for recording images of the passage threshold, to facilitate the displaying of suspicious persons or objects when the detection module has detected the presence of particles of an explosive or of a chemical or biological agent.

5. The system of claim 1, characterized in that the impeller and/or suction members may be arranged in a self-supporting structure for direct emplacement in the passage threshold or area.
